(19) United States
(12) Patent Application Publication
(10) Pub. No.: US 2025/0205099 A1
(43) Pub. Date: Jun. 26, 2025

(54) Leg Support for Orthopaedic Surgery

(71) Applicant: THE JOHNS HOPKINS UNIVERSITY, Baltimore, MD (US)

(72) Inventors: Amiethab Aiyer, Hunt Valley, MD (US); Alec Greenspoon, Hunt Valley, MD (US)

(21) Appl. No.: 18/850,458

(22) PCT Filed: Mar. 24, 2023
(86) PCT No.: PCT/US2023/064944

§ 371 Date: Sep. 24, 2024

Related U.S. Application Data
(60) Provisional application No. 63/323,295, filed on Mar. 24, 2022.

(51) Int. Cl. A61G 13/12; A61G 13/00

(52) U.S. Cl. CPC A61G 13/1245; A61G 13/0036

(57) ABSTRACT

A standardized, sterile device for leg support during orthopaedic surgery, is described herein. The leg support device of the present invention will serve to create a sterile, efficient, easily replicable set up for ankle arthroscopy. The device of the present invention includes a wedge that defines a central recess configured to receive a leg of the patient. The height and size of the device can be customizable to accommodate positioning for ankle arthroscopy procedures regardless of patient size or weight. The device can, in some embodiments, include a sterile sleeve configured to fit the device. The sterile sleeve further allows for easy manipulation of the device during the procedure.

### CROSS-REFERENCE TO RELATED APPLICATIONS

This application claims the benefit of U.S. Provisional Application No. 63/323,295, filed March 24, 2022. The content of the aforementioned application is herein incorporated by reference, in its entirety.

### FIELD OF INVENTION

The present invention relates generally to the field of medical devices. More particularly, the present invention relates to a leg support for facilitating orthopaedic surgery.

### BACKGROUND

There is currently no standardized, sterile set up for arthroscopic ankle surgery. Therefore, solutions include non-sterile holders and non-standardized holders that may be fashioned from supplies in the operating room. Some surgeons elect to use a non-sterile leg holder, which can be challenging to setup and difficulty to manipulate intraoperatively. After arthroscopy is completed, the holder needs to be manually removed by OR staff, which adds time to the case and risks contamination of the sterile field. It is therefore difficult and/or time consuming for orthopaedic surgeons to overcome the shortcomings of these existing positioner solutions.

A standardized, sterile device for leg support during orthopaedic surgery is therefore needed.

### SUMMARY

The foregoing needs are met, to a great extent, by the present invention wherein in one aspect, a device for use during surgery includes a support configured to raise a leg of a patient off of a surgical table. The support is configured to raise a leg off of the surgical table by a predetermined amount.

According to an embodiment of the present invention, the device includes a strap to secure the leg of the patient to the support. The strap to secure the leg of the patient is secured using hook and loop material, belt fastener, or adhesive. The device can also include a strap to secure the support to the surgical table. The strap to secure the device to the surgical table is secured using hook and loop material, belt fastener, or adhesive. The support is formed from a group including plastic, rubber, an inflatable membrane, and foam. The device can include a sterile cover. The device parameters can be adjusted based on subject/patient anatomy and the surgical procedure being performed. The device includes a central recess for receiving the leg of the patient. The central recess is configured based on patient height, patient weight, and surgical procedure being performed.

In accordance with an aspect of the present invention, a wedge-shaped block is configured for placement under a leg of a patient. The wedge-shaped block defines an incline. The incline is at an angle θ, and the angle θ raises the leg of the patient to a predetermined height.

In accordance with another aspect of the present invention, the device includes an end block. The end block is configured to provide additional support for the leg of the patient. The device further includes a strap to secure the leg of the patient to the support. The strap is secured using one selected from a group consisting of hook and loop material, belt fastener, and adhesive. The device also includes a strap to secure the support to the procedure table. The strap is secured to the procedure table using one selected from a group consisting of hook and loop material, belt fastener, and adhesive. The support is formed from one selected from a group consisting of plastic, rubber, an inflatable membrane, and foam. The further includes a sterile cover. The device includes a central recess for receiving the leg of the patient. The central recess is configured based on patient height, patient weight, and surgical procedure being performed.

### BRIEF DESCRIPTION OF THE DRAWINGS

Further objectives and advantages will become apparent from a consideration

of the description, drawings, and examples.

FIG. 1A illustrates an end view of a leg support, according to an embodiment of the present invention.

FIG. 1B illustrates a side view of a leg support, according to an embodiment of the present invention.

FIG. 2A illustrates an end view of a leg support, according to another embodiment of the present invention.

FIG. 2B illustrates a side view of a leg support, according to an embodiment of the present invention.

FIG. 3A illustrates an end view of the leg support of FIG. 1A with a leg positioned in the support, according to an embodiment of the present invention.

FIG. 3B illustrates a side view of the leg support of FIG. 1B with a leg positioned in the support, according to an embodiment of the present invention.

FIG. 4 illustrates a side view of the leg support with a leg positioned in the support, where the leg support includes a leg positioning strap, according to an embodiment of the present invention.

FIG. 5A illustrates a top down view of the leg support positioned on a surgical bed, according to an embodiment of the present invention.

FIG. 5B illustrates a side view of the leg support positioned on a surgical bed, according to an embodiment of the present invention.

### DETAILED DESCRIPTION

The presently disclosed subject matter will now be described more fully hereinafter with reference to the accompanying Drawings, in which some, but not all embodiments of the inventions are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims.

The present invention provides a standardized, sterile device for leg support during orthopaedic surgery. The leg support device of the present invention will serve to create a sterile, efficient, easily replicatable set up for orthopaedic surgeries, such as ankle arthroscopy. The device of the present invention includes a wedge that defines a central recess configured to receive a leg of the patient. The height and size of the device can be customizable to accommodate positioning for ankle arthroscopy procedures regardless of patient size or weight. The device can in some embodiments include a sterile sleeve configured to fit the device. The sterile sleeve further allows for easy manipulation of the device during the procedure.

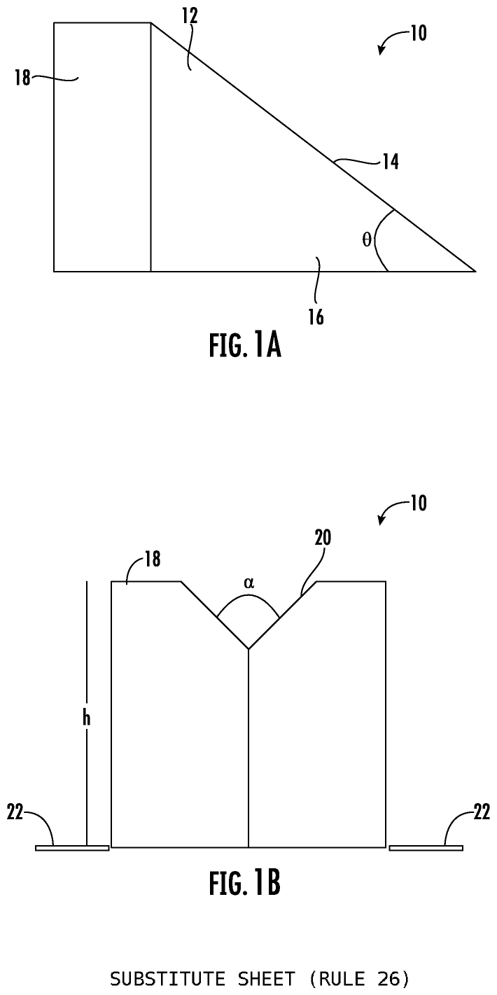

FIG. 1A illustrates a side view of a leg support, according to an embodiment of the present invention. As illustrated in FIG. 1A, the leg support 10 of the present invention takes the form of a block 12 for placement under a leg of the patient. The block 12 of FIG. 1A has a wedge shape, defining incline 14. The incline 14 is at an angle θ configured to raise the patient's leg to an appropriate height for the procedure. The height and size of the device can be adjusted in order to optimize positioning during the surgical procedure across multiple patient body shapes. While the wedge shape is illustrated in FIG. 1A, it should be noted that any shape or configuration suitable for the patient and the procedure can be used. As illustrated in FIG. 1A, the leg support can also include an end block 18. The end block 18 can be immovably attached to or separatable from block 12. The end block 18 provides additional support under the leg of the patient. The leg support 10 can be formed from foam, rubber, plastic, or any other suitable material known to or conceivable to one of skill in the art. In some embodiments the leg support 10 can be inflated with air or fluid in order to vary the support, the height, and or other factors based on the patient and the surgical procedure.

The leg support 10, of FIG. 1A, can also include a sterile cover 16. The sterile cover 16 is, in some embodiments, designed to fit the leg support snugly in order to facilitate easy manipulation during the procedure. The sterile cover 16 allows the leg support 10 to be positioned, moved, and removed easily and quickly during surgical procedures. In addition, the sterile cover 16 allows the surgeon to position the leg during the procedure, after scrubbing in. This allows for the most precise and efficient placement. The sterile cover can be made from any suitable sterile or sterilizable material known to or conceivable to one of skill in the art.

FIG. 1B illustrates an end view a side view of a leg support, according to an embodiment of the present invention. As illustrated in FIG. 1B, the end block 18 of the leg support 10 includes central recess 20 to allow for stable positioning of the leg. In some embodiments, the central recess 20 can be configured based on patient size, weight, and/or surgical procedure. As illustrated in FIG. 1B the central recess 20 takes a triangular shape. However, it should be noted that the central recess can take any shape known to or conceivable to one of skill in the art. The central recess 20 can define an angle α. The angle α can be chosen based on factors including, but not limited to, patient weight, size, height, etc. or based on surgical procedure. The leg support 10 is of a height h. h is selected based on factors including, but not limited to, patient weight, size, height, etc. or based on surgical procedure. The leg support 10 can also include attachments 22 for securing the leg support to a surgical table (not shown). The attachments 22 can be secured to the surgical table with hook and loop material, adhesive strips, belt fasteners, or any other fastening method known to or conceivable to one of skill in the art.

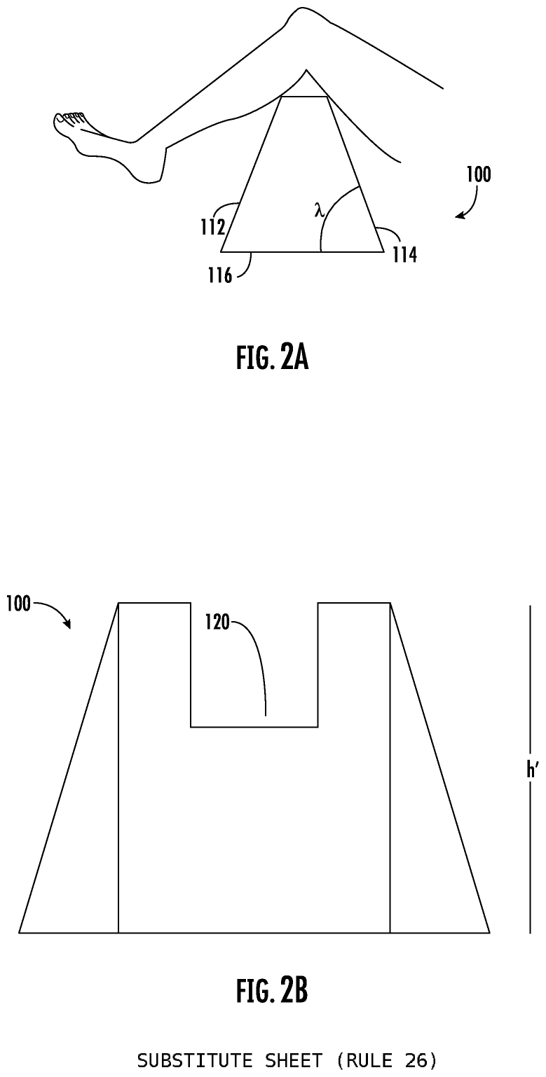

FIG. 2A illustrates a side view of a leg support, according to another embodiment of the present invention. As illustrated in FIG. 2A, the leg support 100 of the present invention takes the form of a block 112 for placement under a leg of the patient. The block 102 of FIG. 1A has a trapezoidal shape, defining incline 114. The incline 114 is at an angle λ configured to raise the patient's leg to an appropriate height for the procedure. The height and size of the device can be adjusted in order to optimize positioning during the surgical procedure across multiple patient body shapes. While the trapezoidal shape is illustrated in FIG. 2A, it should be noted that any shape or configuration suitable for the patient and the procedure can be used. The end block 118 provides additional support under the leg of the patient. The leg support 100 can be formed from foam, rubber, plastic, or any other suitable material known to or conceivable to one of skill in the art.

The leg support 100, of FIG. 2A, can also include a sterile cover 116. The sterile cover 116 is, in some embodiments, designed to fit the leg support snugly in order to facilitate easy manipulation during the procedure. The sterile cover 16 allows the leg support 100 to be positioned, moved, and removed easily and quickly during surgical procedures. In addition, the sterile cover 116 allows the surgeon to position the leg during the procedure, after scrubbing in. This allows for the most precise and efficient placement. The sterile cover can be made from any suitable sterile or sterilizable material known to or conceivable to one of skill in the art. The sterile cover can be sterilizable and reusable or alternately can be sterile and disposable.

FIG. 2B illustrates an end view a side view of a leg support, according to an embodiment of the present invention. As illustrated in FIG. 2B, the leg support 100 includes central recess 120 to allow for stable positioning of the leg. In some embodiments, the central recess 120 can be configured based on patient size, weight, and/or surgical procedure. As illustrated in FIG. 2B the central recess 20 takes a rectangular shape. However, it should be noted that the central recess can take any shape known to or conceivable to one of skill in the art. The leg support 100 is of a height h′. h′ is selected based on factors including, but not limited to, patient weight, size, height, etc. or based on surgical procedure.

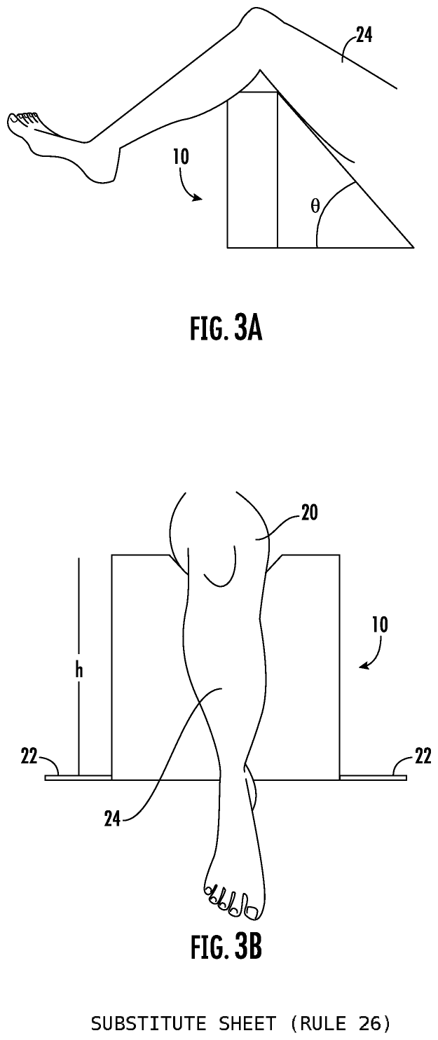

FIG. 3A illustrates a side view of the leg support of FIG. 1A with a leg positioned in the support, according to an embodiment of the present invention, and FIG. 3B illustrates an end view of the leg support of FIG. 1B with a leg positioned in the support, according to an embodiment of the present invention. As illustrated in FIGS. 3A and 3B, the leg support 10, described in detail with respect to FIG. 1A and 1B, raises the patient's leg 24 to a height appropriate for the surgical procedure, such as an ankle arthroscopy. The incline angle θ and the height h of the leg support can be chosen based on factors including, but not limited to, patient weight, size, height, etc. or based on surgical procedure. As illustrated in FIG. 3B, the patient's leg 24 is disposed within the central recess 20.

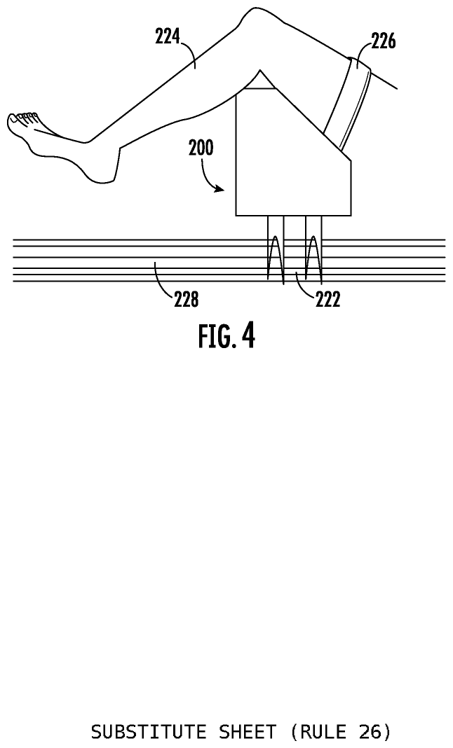

FIG. 4 illustrates a side view of the leg support with a leg positioned in the support, where the leg support includes a leg positioning strap, according to an embodiment of the present invention. As illustrated in FIG. 4, the leg support 200, raises the patient's leg 224 to a height appropriate for the surgical procedure, such as an ankle arthroscopy. The incline angle and the height of the leg support can be chosen based on factors including, but not limited to, patient weight, size, height, etc. or based on surgical procedure. The leg support 200 can include a leg securement strap 226. The leg securement strap 226 can be formed from nylon, polyester, vinyl or other material known to or conceivable to one of skill in the art. The leg securement strap 226 can be secured around the leg with hook and loop material, adhesive strips, belt fasteners, or any other fastening method known to or conceivable to one of skill in the art. The leg securement strap 226 can be incorporated into the design of the sterile cover, can be a separate component, or can be incorporated into the leg support 200 in any other way known to or conceivable to one of skill in the art. The leg support 200 can also include attachments 222 for securing the leg support 200 to a surgical table 228. The attachments 222 can be secured to the surgical table with hook and loop material, adhesive strips, belt fasteners, or any other fastening method known to or conceivable to one of skill in the art.

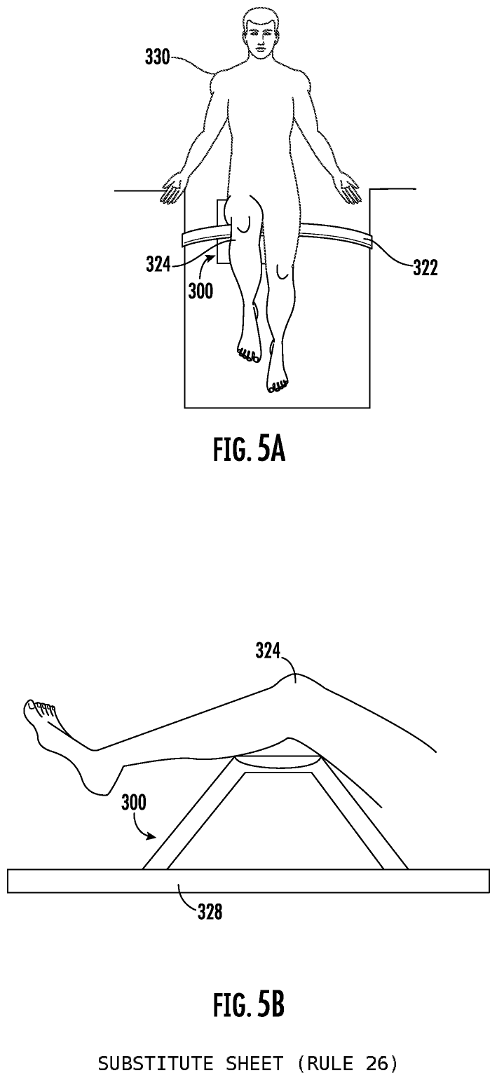

FIG. 5A illustrates a top-down view of the leg support positioned on a surgical bed, according to an embodiment of the present invention, and FIG. 5B illustrates a side view of the leg support positioned on a surgical bed. according to an embodiment of the present invention. FIGS. 5A and 5B show the leg support 300 positioned on a surgical table 328. The patient 330 is disposed on the surgical table 328 and the leg support 300 is adjusted such that the patient's leg 324 is positioned properly for surgery, such as an ankle arthroscopy. Once the leg support 300 is in the desired position, it can be secured to the surgical table 328 with attachments 322.

The embodiments illustrated and discussed in this specification are intended only to teach those skilled in the art how to make and use the invention. In describing embodiments of the invention, specific terminology is employed for the sake of clarity. However, the invention is not intended to be limited to the specific terminology so selected. The above-described embodiments of the invention may be modified or varied, without departing from the invention, as appreciated by those skilled in the art in light of the above teachings. It should also be noted that while the device of the present invention is described with respect to specific surgical procedures, it can be used in conjunction with any surgical procedure known to or conceivable to one of skill in the art. It is therefore to be understood that, within the scope of the claims and their equivalents, the invention may be practiced otherwise than as specifically described.

1. A device comprising:
a support configured to raise a leg of a patient off of a procedure table;
wherein the support is configured to raise the leg off of the procedure table by a predetermined amount.

2. The device of claim 1 further comprising a strap to secure the leg of the patient to the support.

3. The device of claim 2 wherein the strap is secured using one selected from a group consisting of hook and loop material, belt fastener, and adhesive.

4. The device of claim 1 further comprising a strap to secure the support to the procedure table.

5. The device of claim 4 wherein the strap is secured to the procedure table using one selected from a group consisting of hook and loop material, belt fastener, and adhesive.

6. The device of claim 1 wherein the support is formed from one selected from a group consisting of plastic, rubber, an inflatable membrane, and foam.

7. The device of claim 1 further comprising a sterile cover.

8. The device of claim 1 wherein the device parameters can be adjusted based on subject/patient anatomy and the surgical procedure being performed.

9. The device of claim 1 further comprising a central recess for receiving the leg of the patient.

10. The device of claim 9 wherein the central recess is configured based on patient height, patient weight, and surgical procedure being performed.

11. A device comprising:
a wedge-shaped block configured for placement under a leg of a patient, wherein the wedge-shaped block defines an incline, and wherein the incline is at an angle θ, wherein the angle θ raises the leg of the patient to a predetermined height.

12. The device of claim 11 further comprising an end block, wherein the end block is configured to provide additional support for the leg of the patient.

13. The device of claim 11 further comprising a strap to secure the leg of the patient to the support.

14. The device of claim 13 wherein the strap is secured using one selected from a group consisting of hook and loop material, belt fastener, and adhesive.

15. The device of claim 11 further comprising a strap to secure the support to the procedure table.

16. The device of claim 14 wherein the strap is secured to the procedure table using one selected from a group consisting of hook and loop material, belt fastener, and adhesive.

17. The device of claim 11 wherein the support is formed from one selected from a group consisting of plastic, rubber, an inflatable membrane, and foam.

18. The device of claim 11 further comprising a sterile cover.

19. The device of claim 11 further comprising a central recess for receiving the leg of the patient.

20. The device of claim 19 wherein the central recess is configured based on patient height, patient weight, and surgical procedure being performed.
